(19) United States
(12) Patent Application Publication
(10) Pub. No.: US 2024/0147200 A1
(43) Pub. Date: May 2, 2024

(54) SENSOR SHARING MESSAGE COMMUNICATION IN A WIRELESS COMMUNICATION SYSTEM

(71) Applicant: QUALCOMM Incorporated, San Diego, CA (US)

(72) Inventors: Lan Yu, Beijing (CN); Hong Cheng, Basking Ridge, NJ (US); Dan Vassilovski, Del Mar, CA (US)

(21) Appl. No.: 18/548,193

(22) PCT Filed: Apr. 23, 2021
(86) PCT No.: PCT/CN2021/089218

§ 371 Date: Aug. 28, 2023

(51) Int. Cl. H04W 4/38; H04W 4/40

(52) U.S. Cl. CPC H04W 4/38; H04W 4/40

(57) ABSTRACT

A method of wireless communication includes transmitting, by a first device, a sensor sharing message (SSM) associated with a vehicle communication network. The SSM includes first data associated with the first device and further includes second data indicating one or more objects detected by the first device. The method further includes, in response to transmitting the SSM, receiving, by the first device from a second device, an extension request for extension data associated with at least a first object of the one or more objects.

### TECHNICAL FIELD

Aspects of the present disclosure relate generally to wireless communication systems, and more particularly, to wireless communication systems that use sensor sharing messages.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In some aspects of the disclosure, a method of wireless communication includes transmitting, by a first device, a sensor sharing message (SSM) associated with a vehicle communication network. The SSM includes first data associated with the first device and further includes second data indicating one or more objects detected by the first device. The method further includes, in response to transmitting the SSM, receiving, by the first device from a second device, an extension request for extension data associated with at least a first object of the one or more objects.

In some other aspects of the disclosure, an apparatus includes a transmitter configured to transmit, from a first device, an SSM associated with a vehicle communication network. The SSM includes first data associated with the first device and further includes second data indicating one or more objects detected by the first device. The apparatus further includes a receiver configured to receive, in response to transmitting the SSM, an extension request from a second device for extension data associated with at least a first object of the one or more objects.

In some other aspects of the disclosure, a method of wireless communication includes receiving, from a first device and by a second device, an SSM associated with a vehicle communication network. The SSM includes first data associated with the first device and further includes second data indicating one or more objects detected by the first device. The method further includes, in response to receiving the SSM, transmitting, to the first device by the second device, an extension request for extension data associated with at least a first object of the one or more objects.

In some other aspects of the disclosure, an apparatus includes a receiver configured to receive, from a first device and by a second device, an SSM associated with a vehicle communication network. The SSM includes first data associated with the first device and further includes second data indicating one or more objects detected by the first device. The apparatus further includes a transmitter configured to transmit, from the second device to the first device in response to receiving the SSM, an extension request for extension data associated with at least a first object of the one or more objects.

### BRIEF DESCRIPTION OF THE DRAWINGS

FIG. 1 is a block diagram illustrating an example of a wireless communication system according to some aspects of the disclosure.

FIG. 2 is a block diagram illustrating examples of a base station and a UE according to some aspects of the disclosure.

FIG. 3 is a block diagram illustrating another example of a wireless communication system according to some aspects of the disclosure.

FIG. 4 is a ladder diagram illustrating some examples of operations 400 that may be performed based on an environment 450 according to some aspects of the disclosure.

FIG. 5 is a diagram illustrating examples of an uncompressed sensor sharing message (SSM), a first environment, a compressed SSM, and a second environment.

FIG. 6 is a diagram illustrating certain non-limiting examples of an uncompressed SSM, data sizes and variable names that may be associated with portions of the uncompressed SSM, and an extension request according to some aspects of the disclosure.

FIG. 7 is a diagram illustrating some non-limiting examples of a compressed SSM and an extension response according to some aspects of the disclosure.

FIG. 8 is a flow chart of a method of wireless communication according to some aspects of the disclosure.

FIG. 9 is a flow chart of another method of wireless communication according to some aspects of the disclosure.

FIG. 10 is a block diagram illustrating an example of an on-board unit (OBU) device according to some aspects of the disclosure.

FIG. 11 is a block diagram illustrating an example of a roadside unit (RSU) device according to some aspects of the disclosure.

### DETAILED DESCRIPTION

Wireless communication networks enable devices to transmit and receive a wide variety of information. Some examples of wireless communication networks include vehicle-based communication networks that enable wireless communication among vehicles, road infrastructure devices, and other road users (e.g., pedestrians and cyclists). A vehicle may include an on-board unit (OBU) that communicates with a roadside unit (RSU) that may be included in or coupled to a road infrastructure device, such as a traffic signal. Depending on the example, vehicles that communicate using a vehicle-based wireless communication network may be autonomous, partially autonomous, or non-autonomous. An example of a vehicle-based communication network is a vehicle-to-everything (V2E) communication network.

Vehicle-based communication networks may use sensor sharing messages (SSMs) to share information among devices, such as OBUs, RSUs, and other road users. For example, a device may detect an object, such as a vehicle, a pedestrian or other road user (e.g., a vulnerable road user (VRU)), or an obstacle. The device may generate data associated with the object (such as a location of the object, a trajectory of the object, or a status of the object) and may transmit an SSM indicating the data.

In some cases, SSM transmission may incur a relatively large load for the wireless communication network. For example, in dense traffic, a relatively large number of SSMs may be transmitted. In some cases, a relatively large number of SSMs may be transmitted for a single object, such as if each vehicle passing an object during rush hour transmits an SSM indicating characteristics of the object. As a result, a relatively large amount of repetitive information may introduce latency in the communication network, which may in some cases delay transmission or reception of important information (such as an emergency alert).

A wireless communication system in accordance with some aspects of the disclosure may use a two-step SSM transmission technique to reduce channel congestion in a wireless communication network. The two-step SSM transmission technique may use selective compression of SSMs to reduce an amount of data communicated between devices in some cases. For example, a first device may determine whether to transmit an uncompressed SSM or a compressed SSM based on one or more criteria. In some examples, the one or more criteria include one or more of a channel busy rate (CBR) (also referred to as a channel busy ratio) or a number of objects detected by the device.

Based on detecting that the one or more criteria are satisfied, the first device may transmit the compressed SSM. The compressed SSM may exclude certain extension data that is included the uncompressed SSM. For example, the extension data may indicate an estimated size of the object or a confidence level associated with the estimated size. In some cases, a second device receiving the compressed SSM may request the extension data (such as if the second device is to use the estimated size of the object in connection with a maneuver or for trajectory planning). The second device may transmit an extension request for the extension data. The first device may determine whether to accept or reject the extension request, such as based on one or more of the state of the wireless communication network or a priority element indicated by the extension request.

By selectively compressing an SSM, instances of transmission of redundant or unnecessary data may be reduced. As a result, usage of resources of a wireless communication network may be selectively reduced in circumstances associated with heavy network loading, such as during rush hour. In some circumstances, the reduced usage of resources may reduce latency associated with higher priority messages, such as an emergency alert.

To further illustrate, examples in accordance with some aspects of the disclosure may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Indeed, one or more aspects of the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements, integrated chips, and/or other devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. One or more innovations described herein may be practiced in a variety of implementations, including both large/small devices, chip-level components, multi-component systems (e.g. RF-chain, communication interface, processor), distributed arrangements, end-user devices, etc. of varying sizes, shapes, and constitution.

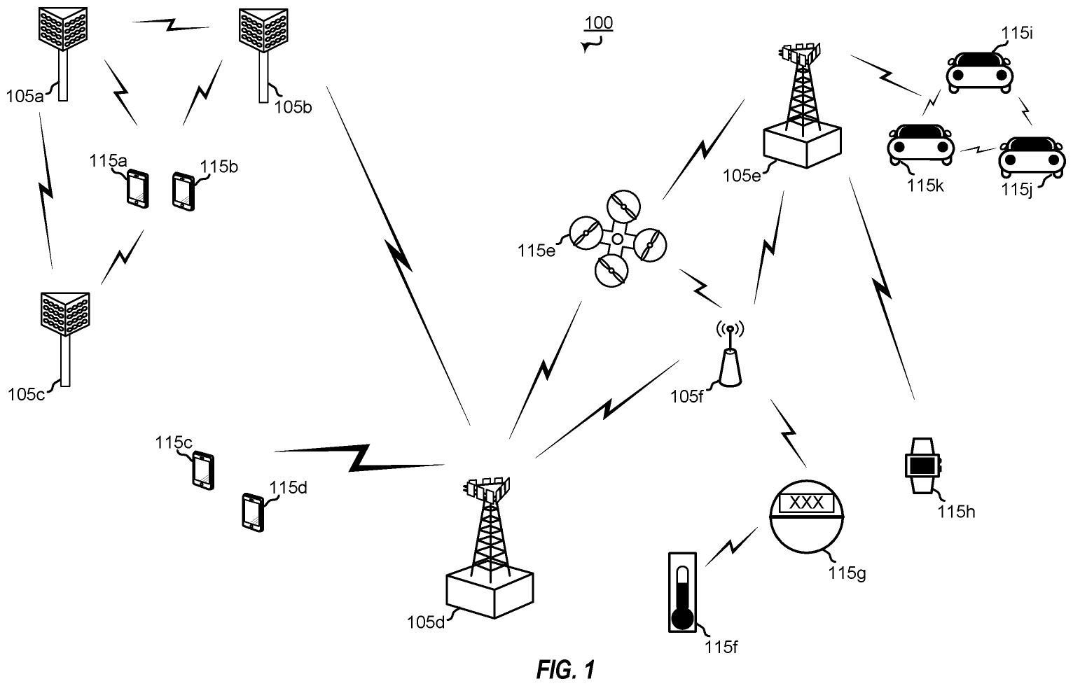

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

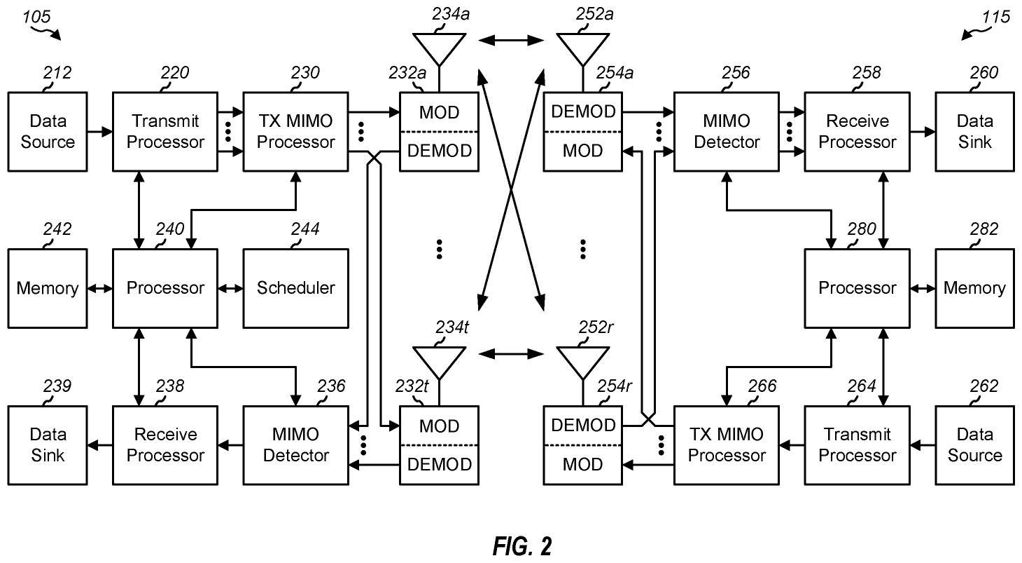

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to processor 280.

On the uplink, at UE 115, transmit processor 264 may receive and process data (e.g., for the physical uplink shared channel (PUSCH)) from data source 262 and control information (e.g., for the physical uplink control channel (PUCCH)) from processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to processor 240.

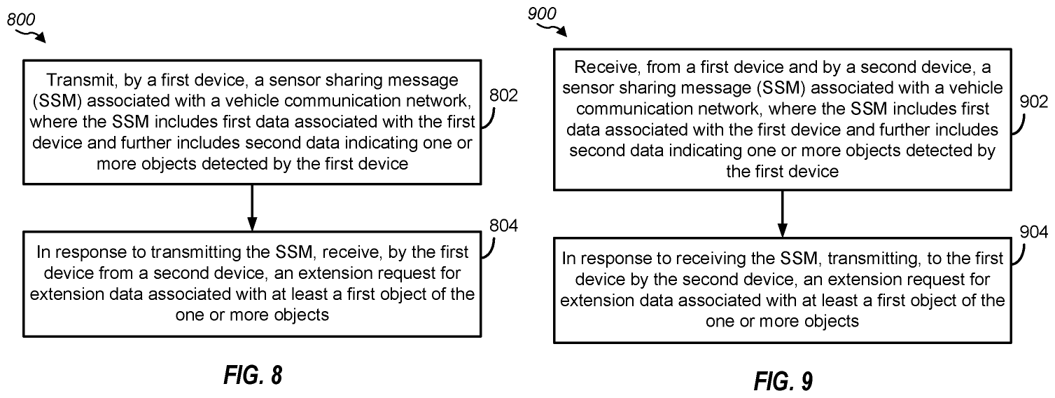

Processors 240 and 280 may direct the operation at base station 105 and UE 115, respectively. Processor 240 and/or other processors and modules at base station 105 and/or processor 280 and/or other processors and modules at UE 115 may perform or direct the execution of various processes for the techniques described herein, such as to perform or direct the execution illustrated in FIGS. 8 and 9 and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

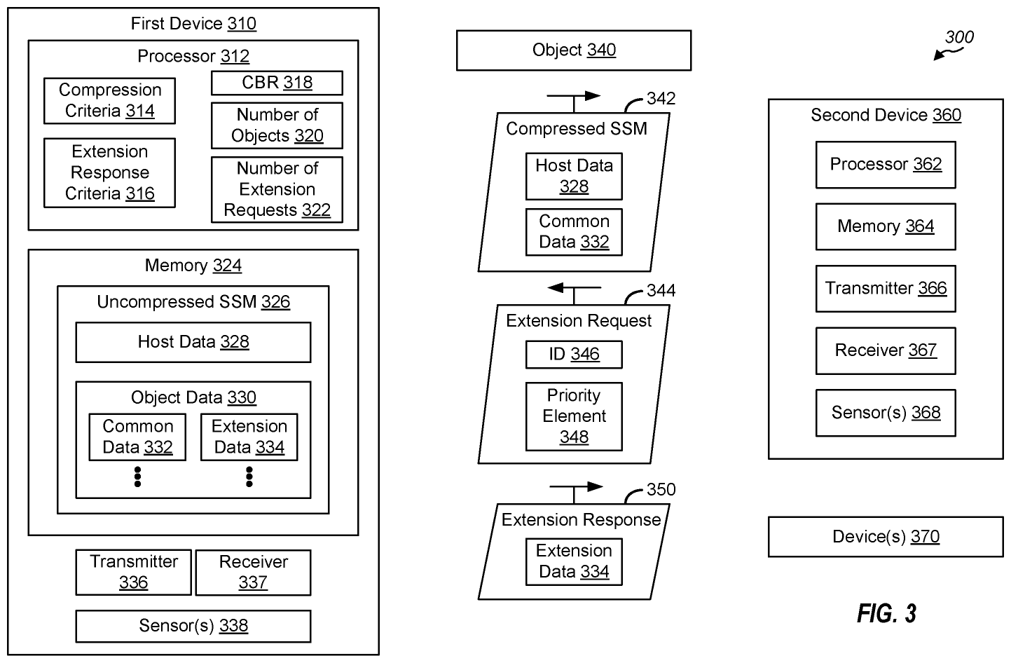

FIG. 3 illustrates another example of a wireless communication system 300 according to some aspects of the disclosure. In some examples, the wireless communication system 300 includes or corresponds to a vehicle communication system that enables communication of data using a vehicle communication network. Examples of vehicle communication networks include vehicle-to-everything (V2E) communication networks, vehicle-to-vehicle (V2V) communication networks, vehicle-to-infrastructure (V2I) communication networks, vehicle-to-pedestrian (V2P) communication networks, vehicle-to-cloud (V2C) communication networks, other vehicle communication networks, or a combination thereof.

In the example of FIG. 3, the wireless communication system 300 may include a first device 310, a second device 360, and one or more other devices 370. Depending on the example, the devices 310, 360, and 370 may each correspond to a vehicle, an on-board unit (OBU) of a vehicle, a roadside unit (RSU), or another device that communicates using a vehicle communication network. Depending on the example, a vehicle may correspond to an autonomous vehicle, a partially autonomous vehicle, or a non-autonomous vehicle. To further illustrate, in some examples, a vehicle may correspond to any of the UEs 115 described with reference to FIGS. 1 and 2, and an RSU may correspond to any of the base stations 105 described with reference to FIGS. 1 and 2. Accordingly, any of the devices 310, 360, and 370 may correspond to a base station 105 or a UE 115.

In the example of FIG. 3, the first device 310 includes a processor 312 and a memory 324 coupled to the processor 312. In one example, the processor 312 corresponds to the processor 240 of FIG. 2, and the memory 324 corresponds to the memory 242 of FIG. 2. In another example, the processor 312 corresponds to the processor 280 of FIG. 2, and the memory 324 corresponds to the memory 282 of FIG. 2. FIG. 3 also illustrates that the first device 310 may include a transmitter 336 and a receiver 337. In an example, the transmitter 336 and the receiver 337 include one or more of the modulator/demodulators 254a-r, the MIMO detector 256, the receive processor 258, the transmit processor 264, or the TX MIMO processor 266. In another example, the transmitter 336 and the receiver 337 include one or more of the modulator/demodulators 232a-t, the MIMO detector 236, the receive processor 238, the transmit processor 220, or the TX MIMO processor 230.

FIG. 3 also depicts that the first device 310 may include one or more sensors 338. To illustrate, the one or more sensors 338 may include an image sensor (e.g., a camera), a microphone, a radar transceiver, a lidar transceiver, an ultrasound transceiver, a Global Positioning System (GPS) receiver, one or more other sensors, or a combination thereof. The one or more sensors 338 may generate sensor data and may provide the sensor data to the processor 312, to the memory 324, or both. Another example of a sensor is a program or application executed by the processor 312 to detect objects, events, or other information, such as an image recognition program executed by the processor 312 to detect objects, events, or other information based on image data generated by an image sensor of the one or more sensors 338.

Further, any of the devices 360 and 370 may include one or more components described with reference to the first device 310. For example, any of the devices 360 and 370 may include a processor corresponding to the processor 312, a memory corresponding to the memory 324, a transmitter corresponding to the transmitter 336, a receiver corresponding to the receiver 337, one or more sensors corresponding to the one or more sensors 338, or a combination thereof. To illustrate, in the example of FIG. 3, the second device 360 includes a processor 362, a memory 364, a transmitter 366, a receiver 367, and one or more sensors 368.

During operation, the first device 310 may use the one or more sensors 338 to generate sensor data. As an illustrative example, the one or more sensors 338 may capture one or more images or a video of surroundings of the first device 310. In one example, the sensor data indicates an object 340, such as a vehicle, a pedestrian or other road user (e.g., a vulnerable road user (VRU)), or an obstacle.

The first device 310 may generate object data 330 based on the sensor data. The object data 330 may include common data 332 and extension data 334 for each detected object. For example, the common data 332 and the extension data 334 may indicate characteristics of the object 340. To further illustrate, the common data 332 may indicate primary characteristics of the object 340, and the extension data 334 may indicate secondary characteristics of the object 340. In some examples, the primary characteristics include at least one feature that is independent of the object type of the object 340 (such as a location of the object 340, and the secondary characteristics include at least one feature that is dependent of the object type of the object 340 (such as a license plate number or a paint color of the object 340, which may depend upon the object type indicating a vehicle and not a pedestrian).

To further illustrate, in some examples, the object 340 corresponds to a vehicle. The common data 332 may indicate one or more of an object type of the vehicle, an identifier (ID) of the vehicle, a type of sensor used to detect the vehicle, a time period used to detect the vehicle, an estimated position of the vehicle, an accuracy of the estimated position, a speed of the vehicle, a heading of the vehicle, a motion confidence set of the vehicle, an estimated vertical speed of the vehicle, a vertical speed confidence of the estimated vertical speed, or an acceleration of the vehicle. The extension data 334 may indicate one or more of a license plate number of the vehicle, an estimated size of the vehicle, a confidence level of the estimated size, a classification of the vehicle, lighting characteristics of the vehicle, an estimated attitude of the vehicle, an attitude confidence of the estimated attitude, an estimated angular velocity of the vehicle, or a confidence level of the estimated angular velocity.

In some examples, the first device 310 generates an uncompressed sensor sharing message (SSM) 326 based on the object data 330. The uncompressed SSM 326 may include host data 328 associated with the first device 310 and may further include the object data 330. In some examples, the host data 328 indicates characteristics of the first device 310, such as an ID of the first device 310 or a number of objects 320 detected by the first device 310.

In some aspects of the disclosure, the first device 310 determines whether to transmit (or generate) either the uncompressed SSM 326 or a compressed SSM 342. In some examples, the uncompressed SSM 326 includes the extension data 334, and the compressed SSM 342 excludes the extension data 334. In this case, the uncompressed SSM 326 may have a first data size (e.g., a first number of bytes), and the compressed SSM 342 may have a second data size (e.g., a second number of bytes) that is less than the first data size. In some examples, whether or not an SSM is compressed or uncompressed is determined based on a bit identifier of an SSM coding process associated with the SSM.

In some aspects, the first device 310 determines whether to transmit the uncompressed SSM 326 or the compressed SSM 342 based on one or more compression criteria 314. To illustrate, in response to determining that the one or more compression criteria 314 are satisfied, the first device 310 may transmit the compressed SSM 342 instead of the uncompressed SSM 326. In another example, in response to determining that the one or more compression criteria 314 are not satisfied, the first device 310 may transmit the uncompressed SSM 326 instead of the compressed SSM 342.

In some implementations, the one or more compression criteria 314 include or are based on one or more channel occupancy or quality metrics, such as a channel busy rate (CBR) 318 (also referred to as a channel busy ratio) determined by the first device 310. To determine the CBR 318, the first device 310 may monitor one or more channels, such as a physical sidelink shared channel (PSSCH), a physical sidelink control channel (PSCCH), one or more other channels, or a combination thereof. The first device 310 may determine a sidelink received signal strength indication (S-RSSI) associated with resources of the monitored one or more channels. The CBR 318 may correspond to a ratio of a number of the resources having an S-RSSI exceeding a threshold S-RSSI to a total number of the resources.

Alternatively or in addition, the one or more compression criteria 314 may include or may be based the number of objects 320 detected by the first device 310. In some examples, the number of objects 320 is indicated by the uncompressed SSM 326 but not by the compressed SSM 342. In a non-limiting example, if only the object 340 is detected, then the number of objects 320 may correspond to a value of one. In other examples, the first device 310 may detect a different number of objects 320. In some examples, the first device 310 may determine the number of objects 320 based on a rolling time interval. For example, at a particular time, the number of objects 320 may indicate the number of objects detected in a particular time interval prior to the particular time (e.g., during the previous five seconds, ten seconds, one minute, or other time interval).

One or more devices of the wireless communication system 300 may receive the uncompressed SSM 326 or the compressed SSM 342 from the first device 310. The one or more devices may use information indicated by the uncompressed SSM 326 or the compressed SSM 342, such as by using information associated with the object 340 in connection with one or more of a maneuver or trajectory planning. As an illustrative example, the one or more devices may perform a lane change based on a position of the object 340 indicated by the uncompressed SSM 326 or the compressed SSM 342.

In some cases, in response to receiving the compressed SSM 342, one or more devices of the wireless communication system 300 may identify that additional information is available from the first device 310. In one example, the second device 360 receives the compressed SSM 342 and determines, based on the compressed SSM 342, that the extension data 334 is available. To illustrate, the compressed SSM 342 may include a flag indicating that the extension data 334 is available, and the second device 360 may determine, based on the flag, that the extension data 334 is available. Alternatively or in addition, the second device 360 may determine that the extension data 334 is available based on the second data size of the compressed SSM 342, such as by identifying that the second data size is less than a data size (or range of data sizes) associated with uncompressed SSMs, such as the first data size of the uncompressed SSM 326.

In response to receiving the compressed SSM 342, one or more devices of the wireless communication system 300 may request additional information from the first device 310. In one example, the second device 360 transmits an extension request 344 for the extension data 334. To illustrate, the second device 360 may transmit the extension request 344 to the first device 310 based on determining that the extension data 334 is to be used in connection with one or more of a maneuver of the second device 360 or trajectory planning of the second device 360.

In some examples, the extension request 344 identifies one or more objects for which the second device 360 requests extension data. To illustrate, the extension request 344 may include an identifier (ID) 346 of the object 340. In some examples, the ID 346 includes or corresponds to an alphanumeric identifier assigned to the object 340 by the first device 310 and indicated by the common data 332.

In some examples, the second device 360 generates the extension request 344 based on one or more parameters associated with the second device 360. To illustrate, the second device 360 may generate the extension request 344 based on a storage capacity or available amount of storage of a memory, such as the memory 364. To further illustrate, if the memory 364 has less storage capacity or available storage, the second device 360 may indicate fewer object IDs via the extension request 344 as compared to if the memory 364 has a greater storage capacity or available storage.

In some implementations, the extension request 344 includes a priority element 348 indicating a priority of the extension request 344. To illustrate, in some examples, the priority element 348 includes or corresponds to a particular value selected from a range of values each corresponding to a different priority (e.g., the range of integers from one to ten, where one indicates the lowest priority, and where ten indicates the greatest priority, such as an emergency). In another example, the priority element 348 may correspond to a flag that is selectively provided to indicate a high priority (e.g., an emergency) or a low priority.

In some examples, the second device 360 may transmit the extension request 344 to multiple devices, such as the first device 310 and at least one other device. To illustrate, in some examples, the multiple devices may transmit compressed SSMs indicating the object 340 (such as where the multiple devices are proximate to the object 340 and detect the object 340 during a common time interval). In this case, in response to receiving the multiple compressed SSMs, the second device 360 may “consolidate” extension requests into the extension request 344 (e.g., instead of transmitting multiple extension requests to the multiple devices). The extension request 344 may include multiple IDs assigned to the object 340 by the multiple devices. For example, in addition to the ID 346 assigned to the object 340 by the first device 310, the extension request 344 may include another ID assigned to the object 340 by the oat least one other device.

In response to receiving the extension request 344, the first device 310 may determine whether to transmit an extension response 350 indicating the extension data 334 to the second device 360. In some examples, the first device determines whether one or more extension response criteria 316 for transmission of the extension response 360 are satisfied. The first device 310 may transmit the extension response 350 based on determining that the one or more extension response criteria 316 are satisfied. In some other examples, the first device 310 may decline to transmit the extension response 350 based on determining that the one or more extension response criteria 316 are not satisfied.

To illustrate, in some examples, the first device 310 may determine whether the one or more extension response criteria 316 are satisfied based on one or more of the CBR 318 or the number of objects 320. To illustrate, as the CBR 318 increases, the first device 310 may avoid transmitting the extension response 350 (e.g., to avoid interfering with other messages, which may be associated with a higher priority than the extension response 350). In this case, the first device 310 may determine that the one or more extension response criteria 316 are satisfied based on the CBR 318 failing to satisfy a threshold CBR value. In another example, as the number of objects 320 increases, an amount of data or number of communications transmitted in the wireless communication system 300 may increase. In this case, the first device 310 may determine that the one or more extension response criteria 316 are satisfied based on the number of objects 320 failing to satisfy a threshold CBR value. In some examples, the one or more compression criteria 314 indicate a first threshold CBR value, and the one or more extension response criteria 316 indicate a second CBR threshold value that is different than the first threshold CBR value.

In addition, the first device 310 may determine whether the one or more extension response criteria 316 are satisfied based on the priority element 348. To illustrate, in one example, if the priority element 348 has a value that satisfies a threshold priority value, then the first device 310 may determine that the one or more extension response criteria 316 are satisfied. As a non-limiting example, the priority element 348 may have a value selected from the range of integers from one to ten, and the threshold priority value may correspond to a value of five. In this example, the first device 310 may determine that the one or more extension response criteria 316 are satisfied based on the priority element 348 indicating a value in the range of five to ten and may determine that the one or more extension response criteria 316 are not satisfied based on the priority element 348 indicating a value in the range of one to four. In another example, the priority element 348 may correspond to a flag, and the first device 310 may determine that the one or more extension response criteria 316 are satisfied based on presence of the priority element 348 in the extension request 344 (such as where the priority element 348 corresponds to a high priority or emergency flag) or absence of the priority element 348 in the extension request 344 (such as where the priority element 348 corresponds to a low priority flag).

Alternatively or in addition, the first device 310 may determine whether the one or more extension response criteria 316 are satisfied based on a number of extension requests 322 received by the first device 310 and indicating the object 340. To illustrate, a relatively large number of extension requests 322 associated with the object 340 may indicate a relatively large importance of the object 340 to other vehicles or devices. As a result, the first device 310 may determine that the one or more extension response criteria 316 are satisfied based on the number of extension requests 322 satisfying a threshold number of extension requests.

In some implementations, the first device 310 selects a transmission mode for transmission of the extension response 350. The first device 310 may transmit the extension response 350 based on the selected transmission mode. Depending on the example, the transmission mode may correspond to a unicast transmission mode, a broadcast transmission mode, a groupcast transmission mode, or another transmission mode.

To illustrate, in some examples, the first device 310 selects the unicast transmission mode based on the number of extension requests 322. For example, if the number of extension requests 322 corresponds to one, the first device 310 may select the unicast transmission mode and may transmit the extension response 350 to one device (e.g., to the second device 360) based on the unicast transmission mode.

In another example, the first device 310 selects the broadcast or groupcast transmission mode based on the number of extension requests 322. To illustrate, in some examples, the number of extension requests 322 may correspond to two or more, such as if the first device 310 receives one or more extension requests from the one or more devices 370 indicating the object 340 (in addition to the extension request 344 from the second device 360). In this example, the first device 310 may select the broadcast or groupcast transmission mode and may transmit the extension response 350 to the second device 360 and to the one or more other devices 370 based on the broadcast or groupcast transmission mode.

Alternatively or in addition, the first device 310 may select the broadcast or groupcast transmission mode based on beam directions associated with the devices 360, 370. As an example, the first device 310 may determine (e.g., using one or more antenna panels of the first device 310) beam directions associated with extension requests received from the devices 360, 370 (such as the extension request 344). The first device 310 may determine, based on the beam directions, that the devices 360, 370 are within a particular range of one another. In some examples, the first device 310 directionally transmits (e.g., using one or more antenna panels of the first device 310) the extension response 350 to a particular area or region based on the beam directions.

In some examples, the first device 310 selects among the broadcast and groupcast transmission modes based on the number of extension requests 322. For example, if the number of extension requests 322 satisfies a broadcast threshold, then then first device 310 may select the broadcast transmission mode (e.g., to reduce a number of requestor identifiers included in the extension response 350). In this example, use of the broadcast transmission mode may reduce a data size of the extension response 350 (which may otherwise be relatively large due to a relatively large number of requestor identifiers). In some other examples, the first device 310 may select the groupcast transmission mode if the number of extension requests 322 fails to satisfy the broadcast threshold (such as if the number of extension requests 322 is relatively small, such as if the number of extension requests 322 corresponds to two).

In some examples, the first device 310 selects a modulation and coding scheme (MCS) based on the transmission mode of the extension response 350. To illustrate, the first device 310 may transmit the compressed SSM 342 using a first MCS and based on the unicast transmission mode. In response to selecting the broadcast or groupcast transmission mode for the extension response 350, the first device 310 may select a second MCS different than the first MCS based on the broadcast or groupcast transmission mode. The first device 310 may transmit the extension response 350 based on the second MCS.

In some examples, use of the second MCS increases efficiency in the wireless communication system 300 as compared to the first MCS. To illustrate, in some examples, the first MCS is associated with a first spectrum efficiency metric, and the second MCS is associated with a second spectrum efficiency metric that is greater than the first spectrum efficiency metric. Alternatively or in addition, the compressed SSM 342 may be transmitted using a first number of resources, and the extension response 350 may be transmitted using a second number of resources that is less than the first number of resources. In this example, the first MCS may be associated with (or may result in use of) the first number of resources, and the second MCS may be associated with (or may result in use of) the second number of resources.

The second device 360 may receive the extension response 350. In some examples, the second device 360 uses the extension data 334 during operation of the second device 360. For example, the second device 360 may use the extension data 334 in connection with one or more of a maneuver of the second device 360 or trajectory planning of the second device 360.

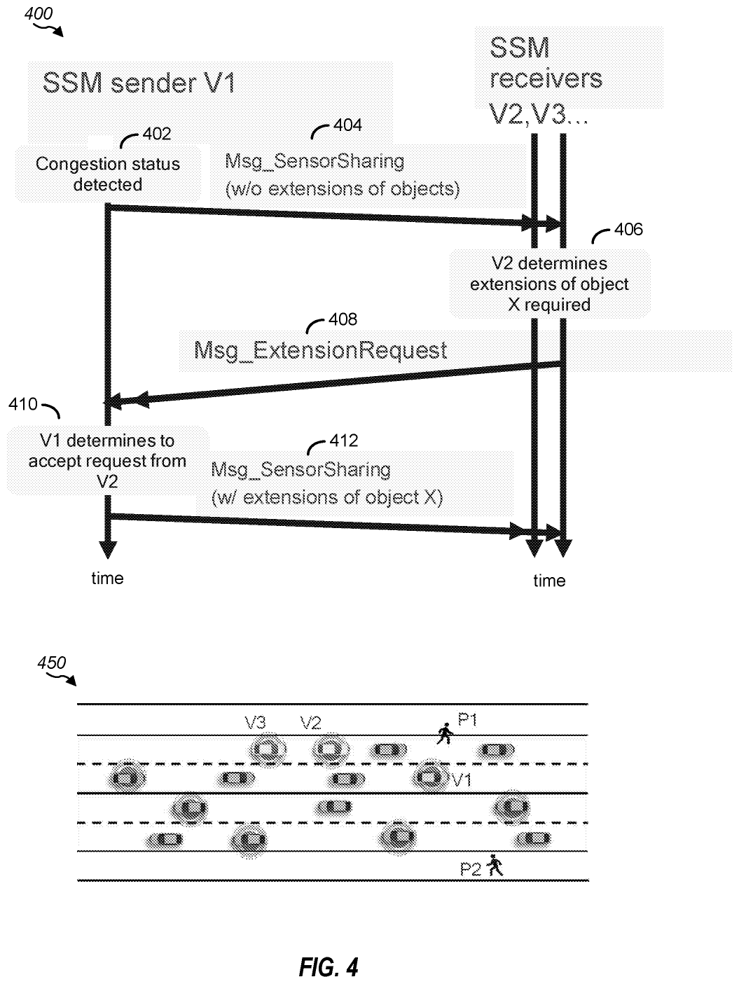

FIG. 4 is a ladder diagram illustrating some examples of operations 400 that may be performed based on an environment 450 according to some aspects of the disclosure. The operations 400 may be performed by a first vehicle V1(e.g., the first device 310), a second vehicle V2 (e.g., the second device 360), and a third vehicle V3 (e.g., a vehicle of the one or more devices 370).

The operations 400 may include detecting, at 402, a congestion status associated with the environment 450. In some examples, the congestion status corresponds to the CBR 318. In an example, the first device 310 may detect that the one or more compression criteria 314 are satisfied based on the CBR 318.

The operations 400 may further include transmitting, based on the detected congestion status, a first SSM without extensions of objects, at 404. For example, the first device 310 may transmit the compressed SSM 342.

The operations 400 may further include determining, by one or more of the vehicles V2 and V3, to request extensions of one or more objects indicated by the first SSM, at 406. For example, any of the devices 360 and 370 may determine to request the extension data 334. In some examples, the vehicles V2 and V3 determine that a first pedestrian P1 is proximate to trajectories of the vehicles V2 and V3 and that a second pedestrian P2 is not proximate to the trajectories of the vehicles V2 and V3. In this case, the vehicles V2 and V3 may determine to request extensions of the first pedestrian P1 and not the second pedestrian P2. In some examples, the first pedestrian P1 corresponds to the object 340.

The operations 400 may further include transmitting an extension request, at 408. For example, any of the devices 360 and 370 may transmit the extension request 344. In some examples, the extension request 344 requests extension data associated with the first pedestrian P1 without request extension data associated with the second pedestrian P2.

The operations 400 may further include determining whether to accept the extension request, at 410. For example, the first device 310 may determine whether to transmit the extension response 350 based on whether the one or more extension response criteria 316 are satisfied.

The operations 400 may further include transmitting a second SSM based on determining to accept the extension request, at 412. In the example of FIG. 4, the second SSM includes the extensions excluded from the first SSM. For example, the first device 310 may transmit the extension response 350 to any of the devices 360 and 370.

To further illustrate, in one example, the vehicles V2 and V3 request extension data associated with the first pedestrian P1 from the first vehicle V1. Because the request is associated with a single destination (the first vehicle V1), the vehicles V2 and V3 may transmit the request based on a unicast transmission mode. In an example, the first vehicle V1 may transmit the extension data to the vehicles V2 and V3 using a groupcast transmission mode.

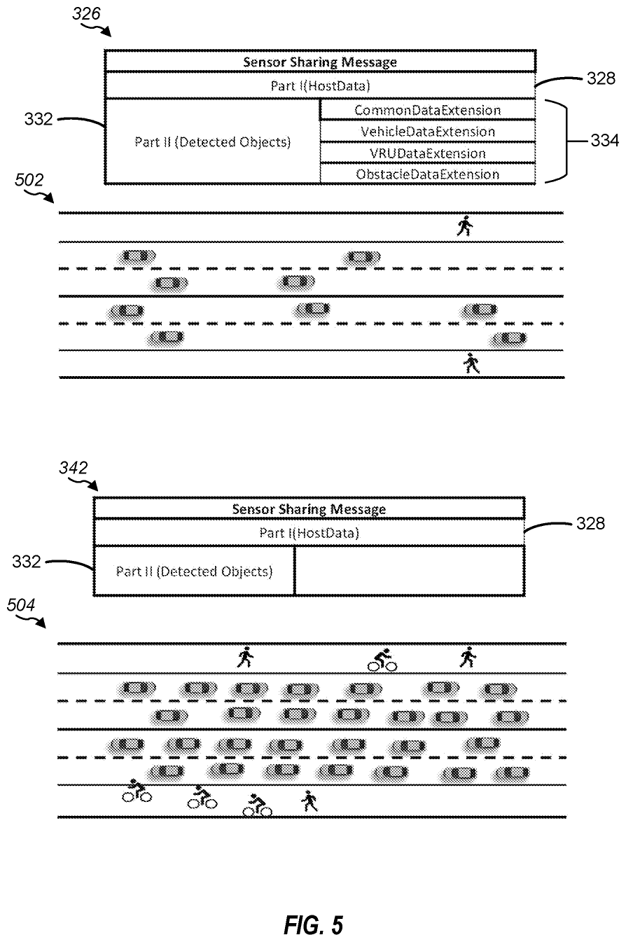

FIG. 5 is a diagram illustrating examples of the uncompressed SSM 326, a first environment 502, the compressed SSM 342, and a second environment 504. FIG. 5 depicts that the uncompressed SSM 326 and the compressed SSM 342 may include the host data 328 and the common data 332. FIG. 5 also illustrates that the uncompressed SSM 326 may include the extension data 334 and that the compressed SSM 342 may exclude the extension data 334.

In some examples, a device of FIG. 5 may transmit the uncompressed SSM 326 based on one or more characteristics of the first environment 502. For example, a device of FIG. 5 may detect that the one or more compression criteria 314 are not satisfied based on one or more characteristics of the first environment 502, such as the CBR 318, the number of objects 320, one or more other parameters, or a combination thereof. In some other examples, a device of FIG. 5 may transmit the compressed SSM 342 based on one or more characteristics of the second environment 504. For example, a device of FIG. 5 may detect that the one or more compression criteria 314 are satisfied based on one or more characteristics of the second environment 504, such as the CBR 318, the number of objects 320, one or more other parameters, or a combination thereof.

In some examples, the first environment 502 corresponds to a particular context associated with a location (e.g., a non-rush hour context), the second environment 504 corresponds to another context associated with the location (e.g., a rush hour context). The first environment 502 may be associated with a first vehicle density, and the second environment 504 may be associated with a second vehicle density that is greater than the first vehicle density.

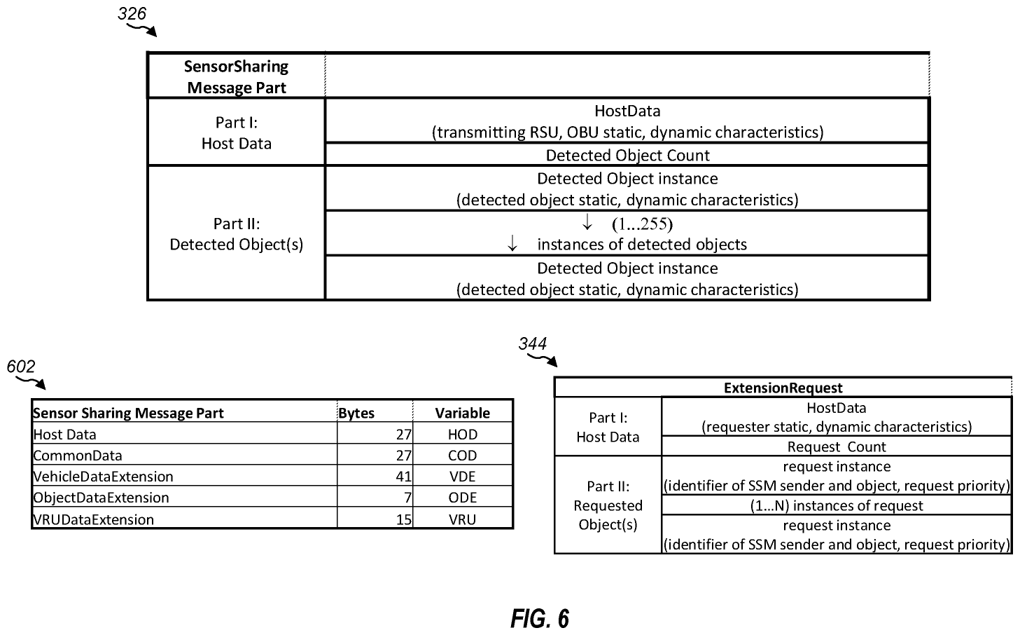

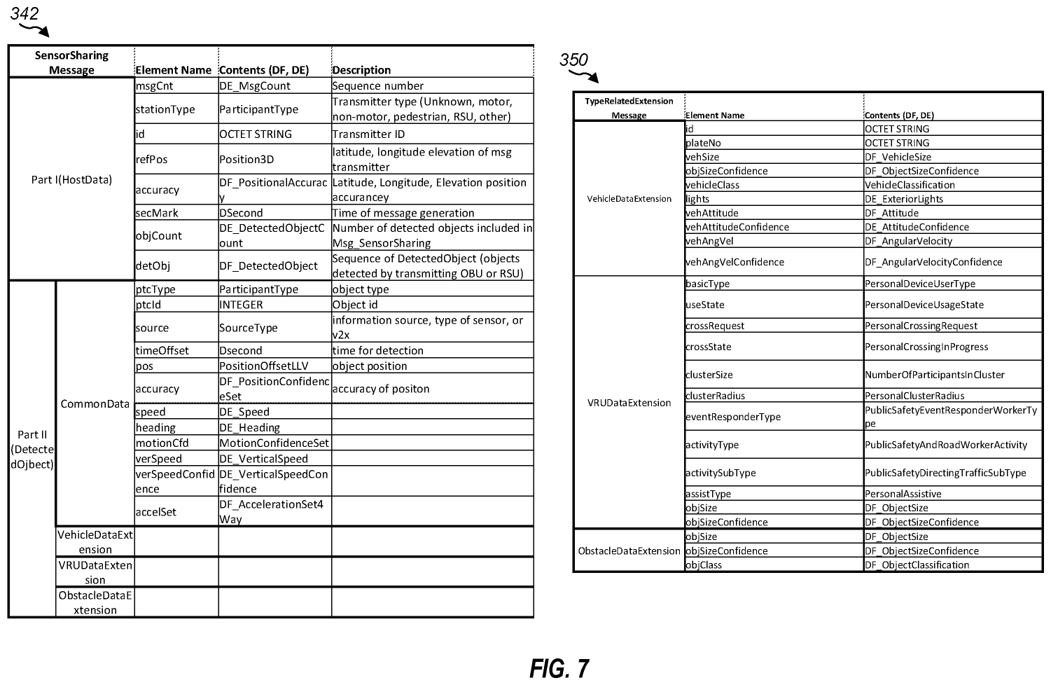

To further illustrate, FIG. 6 is a diagram illustrating certain non-limiting examples of the uncompressed SSM 326, data sizes and variable names 602 that may be associated with certain portions of the uncompressed SSM 326, and the extension request 344 according to some aspects of the disclosure. FIG. 7 is a diagram illustrating some non-limiting examples of the compressed SSM 342 and the extension response 350 according to some aspects of the disclosure.

In some examples, certain messages described with reference to FIGS. 3-7 may be combined (e.g., “consolidated”) into a single message. To illustrate, FIG. 6 depicts that the extension request 344 may indicate multiple request instances that are consolidated into the extension request 344. Each of the multiple request instances may indicate a particular object for which extension data is requested. In some examples, the multiple request instances are transmitted in response to a single compressed SSM. For example, if the compressed SSM 342 indicates multiple objects, the second device 360 may request extension data for the multiple objects using the multiple request instances in a single extension request 344. The second device 360 may transmit the extension request 344 to the first device 310 based on a unicast transmission mode. In some other examples, the multiple request instances are transmitted in response to multiple compressed SSMs, such as the compressed SSM 342 from the first device 310 and one or more other compressed SSMs from the one or more devices 370. The second device 360 may transmit the extension request 344 to the first device 310 and to the one or more other devices 370 based on a broadcast or groupcast transmission mode.

One or more messages or operations described with reference to FIGS. 3-7 may comply with one or more wireless or wired communication protocols or technical specifications. For example, one or more messages or operations described with reference to FIGS. 3-7 may comply with a Society of Automotive Engineers (SAE) technical specification, a European Telecommunications Standards Intelligent Transport Systems (ETSI-ITS) technical specification, or a 3GPP technical specification, as illustrative examples. In some examples, a communication protocol or technical specification may be associated with an application layer of a device (and may also referred to as an application layer specification).

One or more aspects described herein may improve performance of a wireless communication system. For example, by selectively compressing an SSM, instances of transmission of redundant or unnecessary data may be reduced. As a result, usage of resources of a wireless communication network may be selectively reduced in circumstances associated with heavy network loading, such as during rush hour. In some circumstances, the reduced usage of resources may reduce latency associated with higher priority messages, such as an emergency alert.

FIG. 8 is a flow chart of a method 800 of wireless communication according to some aspects of the disclosure. In some examples, the method 800 may be performed by any of the devices 310, 360, and 370 of FIG. 3.

The method 800 includes transmitting, by a first device, an SSM associated with a vehicle communication network, at 802. The SSM includes first data (e.g., the host data 328) associated with the first device and further includes second data (e.g., the common data 332) indicating one or more objects detected by the first device. For example, the first device 310 may transmit the compressed SSM 342, and the compressed SSM 342 may include the host data 328 and the common data 332 indicating the object 340. In some examples, the transmitter 336 is configured to transmit the compressed SSM 342.

The method 800 further includes, in response to transmitting the SSM, receiving, by the first device from a second device, an extension request for extension data associated with at least a first object of the one or more objects, at 804. For example, in response to transmitting the compressed SSM 342, the first device 310 may receive, from the second device 360, the extension request 344 for the extension data 334. In some examples, the receiver 337 is configured to receive the extension request 344.

The method 800 may further include transmitting an extension response based on the extension request. For example, the transmitter 336 may be configured to transmit the extension response 350 based on the extension request 344.

FIG. 9 is a flow chart of a method 900 of wireless communication according to some aspects of the disclosure. In some examples, the method 900 may be performed by any of the devices 310, 360, and 370 of FIG. 3.

The method 900 includes receiving, from a first device and by a second device, an SSM associated with a vehicle communication network, at 902. The SSM includes first data (e.g., the host data 328) associated with the first device and further includes second data (e.g., the common data 332) indicating one or more objects detected by the first device. For example, the second device 360 may receive the compressed SSM 342 from the first device 310, and the compressed SSM 342 may include the host data 328 and the common data 332 indicating the object 340. In some examples, the receiver 367 is configured to receive the compressed SSM 342.

The method 900 further includes, in response to receiving the SSM, transmitting, to the first device by the second device, an extension request for extension data associated with at least a first object of the one or more objects, at 904. For example, in response to receiving the compressed SSM 342 from the first device 310, the second device 360 may transmit the extension request 344 for the extension data 334 to the first device 310. In some examples, the transmitter 366 is configure to transmit the extension request 344 based on the compressed SSM 342.

The method 900 may further include receiving an extension response based on the extension request. For example, the receiver 367 may be configured to receive the extension response 350 based on the extension request 344.

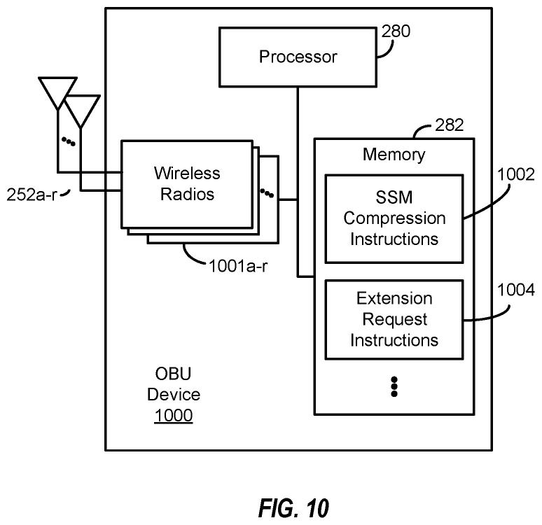

FIG. 10 is a block diagram illustrating an example of an OBU device 1000 according to some aspects of the disclosure. In some examples, the OBU device 1000 may correspond to any of the devices 310, 360, and 370 of FIG. 3. The OBU device 1000 may include certain structure, hardware, or components illustrated in FIG. 2. For example, the OBU device 1000 may include the processor 280, which may execute instructions stored in the memory 282. Using the processor 280, the OBU device 1000 may transmit and receive signals via wireless radios 1001a-r and antennas 252a-r. The wireless radios 1001a-r may include one or more components or devices described herein, such as the modulator/demodulators 254a-r, the MIMO detector 256, the receive processor 258, the transmit processor 264, the TX MIMO processor 266, the transmitter 336 or the transmitter 366, the receiver 337 or the receiver 367, one or more other components or devices, or a combination thereof.

In some examples, the processor 280 executes SSM compression instructions 1002 to generate and transmit the compressed SSM 342 (e.g., based on the one or more compression criteria 314). Alternatively or in addition, the processor 280 may execute the SSM compression instructions 1002 to receive a compressed SSM, such as the compressed SSM 342. The processor 280 may execute extension request instructions 1004 to receive the extension request 344 and to determine whether to transmit the extension response 350 (e.g., based on the one or more extension response criteria 316). Alternatively or in addition, the processor 280 may execute the extension request instructions 1004 to transmit an extension request, such as the extension request 344.

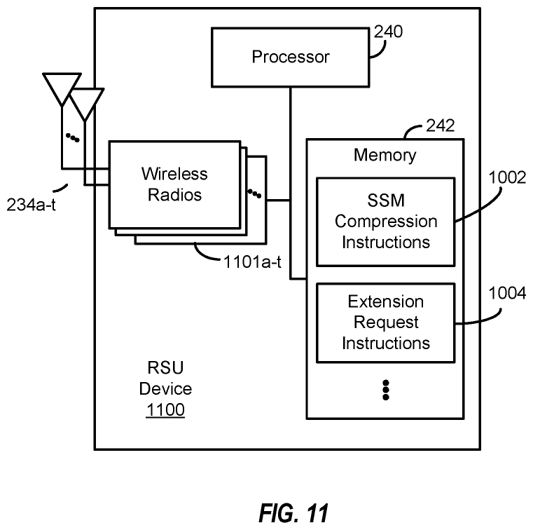

FIG. 11 is a block diagram illustrating an example of an RSU device 1100 according to some aspects of the disclosure. The RSU device 1100 may include structure, hardware, and components illustrated in FIG. 2. For example, the RSU device 1100 may include the processor 240, which may execute instructions stored in memory 242. Under control of the processor 280 240, the RSU device 1100 may transmit and receive signals via wireless radios 1101a-t and antennas 234a-t. The wireless radios 1101a-t may include one or more components or devices described herein, such as the modulator/demodulators 232a-t, the MIMO detector 236, the receive processor 238, the transmit processor 220, the TX MIMO processor 230, the transmitter 336 or the transmitter 366, the receiver 337 or the receiver 367, one or more other components or devices, or a combination thereof.

In some examples, the processor 240 executes the SSM compression instructions 1002 to generate and transmit the compressed SSM 342 (e.g., based on the one or more compression criteria 314). Alternatively or in addition, the processor 240 may execute the SSM compression instructions 1002 to receive a compressed SSM, such as the compressed SSM 342. The processor 240 may execute the extension request instructions 1004 to receive the extension request 344 and to determine whether to transmit the extension response 350 (e.g., based on the one or more extension response criteria 316). Alternatively or in addition, the processor 240 may execute the extension request instructions 1004 to transmit an extension request, such as the extension request 344.

In a first aspect, a method of wireless communication includes transmitting, by a first device, an SSM associated with a vehicle communication network. The SSM includes first data associated with the first device and further includes second data indicating one or more objects detected by the first device. The method further includes, in response to transmitting the SSM, receiving, by the first device from a second device, an extension request for extension data associated with at least a first object of the one or more objects.

In a second aspect alternatively or in addition to the first aspect, the method includes, prior to transmitting the SSM, generating, by the first device, an uncompressed SSM that includes the first data, the second data, and the extension data.

In a third aspect alternatively or in addition to one or more of the first through second aspects, the method includes determining, by the first device, whether one or more compression criteria are satisfied, and the first device transmits the SSM instead of the uncompressed SSM based on identifying that the one or more compression criteria are satisfied.

In a fourth aspect alternatively or in addition to one or more of the first through third aspects, the one or more compression criteria are based on one or more of a CBR determined by the first device or a number of objects detected by the first device and indicated by the uncompressed SSM.

In a fifth aspect alternatively or in addition to one or more of the first through fourth aspects, the uncompressed SSM has a first data size, and the SSM has a second data size that is less than the first data size.

In a sixth aspect alternatively or in addition to one or more of the first through fifth aspects, the method includes, based on receiving the extension request, determining, by the first device, whether one or more extension response criteria for transmission of an extension response are satisfied.

In a seventh aspect alternatively or in addition to one or more of the first through sixth aspects, the method includes transmitting the extension response indicating the extension data based on determining that the one or more extension response criteria are satisfied.

In an eighth aspect alternatively or in addition to one or more of the first through seventh aspects, the method includes declining to transmit the extension response indicating the extension data based on determining that the one or more extension response criteria are not satisfied.

In a ninth aspect alternatively or in addition to one or more of the first through eighth aspects, determining whether the one or more extension response criteria are satisfied is based on a priority element indicated by the extension request.

In a tenth aspect alternatively or in addition to one or more of the first through ninth aspects, determining whether the one or more extension response criteria are satisfied is based on a number of extension requests received by the first device and indicating the first object.

In an eleventh aspect alternatively or in addition to one or more of the first through tenth aspects, determining whether the one or more extension response criteria are satisfied is based on one or more of a CBR determined by the first device or a number of objects detected by the first device.

In a twelfth aspect alternatively or in addition to one or more of the first through eleventh aspects, the method includes selecting, by the first device, a transmission mode for an extension response indicating the extension data and transmitting, by the first device, the extension response based on the transmission mode.

In a thirteenth aspect alternatively or in addition to one or more of the first through twelfth aspects, the transmission mode corresponds to a unicast transmission mode.

In a fourteenth aspect alternatively or in addition to one or more of the first through thirteenth aspects, the transmission mode corresponds to broadcast or groupcast transmission mode, and the first device transmits the extension response to the second device and to one or more other devices.

In a fifteenth aspect alternatively or in addition to one or more of the first through fourteenth aspects, receiving one or more other extension requests from the one or more other devices, the first device selects the broadcast or groupcast transmission mode based on a number of extension requests indicating the first object.

In a sixteenth aspect alternatively or in addition to one or more of the first through fifteenth aspects, the first device selects the broadcast or groupcast transmission mode based on determining that that the second device and the one or more other devices are within a particular range of one another.

In a seventeenth aspect alternatively or in addition to one or more of the first through sixteenth aspects, the first device transmits the SSM using a first modulation and coding scheme (MCS) and based on a unicast transmission mode, and the method includes selecting a second MCS for transmission of the extension response based on the broadcast or groupcast transmission mode.

In an eighteenth aspect alternatively or in addition to one or more of the first through seventeenth aspects, the first MCS is associated with a first spectrum efficiency metric, and the second MCS is associated with a second spectrum efficiency metric that is greater than the first spectrum efficiency metric.

In a nineteenth aspect alternatively or in addition to one or more of the first through eighteenth aspects, the SSM is transmitted using a first number of resources, and the extension response is transmitted using a second number of resources that is less than the first number of resources.

In a twentieth aspect alternatively or in addition to one or more of the first through nineteenth aspects, an apparatus includes a transmitter configured to transmit, from a first device, an SSM associated with a vehicle communication network. The SSM includes first data associated with the first device and further includes second data indicating one or more objects detected by the first device. The apparatus further includes a receiver configured to receive, in response to transmitting the SSM, an extension request from a second device for extension data associated with at least a first object of the one or more objects.

In a twenty-first aspect alternatively or in addition to one or more of the first through twentieth aspects, the first device corresponds to an on-board unit (OBU) of a vehicle, a roadside unit (RSU), or another device that communicates using the vehicle communication network.

In a twenty-second aspect alternatively or in addition to one or more of the first through twenty-first aspects, the second device corresponds to an on-board unit (OBU) of a vehicle, a roadside unit (RSU), or another device that communicates using the vehicle communication network.

In a twenty-third aspect alternatively or in addition to one or more of the first through twenty-second aspects, the first object corresponds to a vehicle, a vulnerable road user (VRU), or an obstacle.

In a twenty-fourth aspect alternatively or in addition to one or more of the first through twenty-third aspects, a method of wireless communication includes receiving, from a first device and by a second device, an SSM associated with a vehicle communication network. The SSM includes first data associated with the first device and further includes second data indicating one or more objects detected by the first device. The method further includes, in response to receiving the SSM, transmitting, to the first device by the second device, an extension request for extension data associated with at least a first object of the one or more objects.

In a twenty-fifth aspect alternatively or in addition to one or more of the first through twenty-fourth aspects, the method includes receiving, from the first device based on the extension request, an extension response indicating the extension data.

In a twenty-sixth aspect alternatively or in addition to one or more of the first through twenty-fifth aspects, the second device transmits the extension request to the first device based on determining that the extension data is to be used in connection with one or more of a maneuver of the second device or trajectory planning of the second device.

In a twenty-seventh aspect alternatively or in addition to one or more of the first through twenty-sixth aspects, the second device transmits the extension request to at least one other device.

In a twenty-eighth aspect alternatively or in addition to one or more of the first through twenty-seventh aspects, the extension request includes a priority element indicating a priority associated with the extension request.

In a twenty-ninth aspect alternatively or in addition to one or more of the first through twenty-eighth aspects, an apparatus includes a receiver configured to receive, from a first device and by a second device, an SSM associated with a vehicle communication network. The SSM includes first data associated with the first device and further includes second data indicating one or more objects detected by the first device. The apparatus further includes a transmitter configured to transmit, from the second device to the first device in response to receiving the SSM, an extension request for extension data associated with at least a first object of the one or more objects.

In a thirtieth aspect alternatively or in addition to one or more of the first through twenty-ninth aspects, the first object corresponds to a vehicle, a vulnerable road user (VRU), or an obstacle, the first device corresponds to an on-board unit (OBU) of a vehicle, a roadside unit (RSU), or another device that communicates using the vehicle communication network, and the second device corresponds to an OBU of a vehicle, an RSU, or another device that communicates using the vehicle communication network.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, or devices described herein (e.g., the functional blocks and devices in FIG. 2) may include one or more processors, electronics devices, hardware devices, electronics components, logical circuits, memories, software codes, firmware codes, etc., or any combination thereof. In addition, one or more features described herein may be implemented via specialized processor circuitry, via executable instructions, and/or combinations thereof.

Those of skill would further appreciate that the various illustrative logical blocks, devices, circuits, and operations (e.g., the operations of FIGS. 8 and 9) described herein may be implemented using electronic hardware, processor-executable instructions, or combinations of both. To illustrate, various illustrative components, blocks, devices, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, devices, and circuits described herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or process described herein may be implemented using hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored as one or more instructions or code on a computer-readable medium. Computer-readable storage media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items may be employed by itself, or any combination of two or more of the listed items may be employed. For example, if a composition is described as containing components A, B, and/or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication, comprising:
transmitting, by a first device, a sensor sharing message (SSM) associated with a vehicle communication network, wherein the SSM includes first data associated with the first device and further includes second data indicating one or more objects detected by the first device; and
in response to transmitting the SSM, receiving, by the first device from a second device, an extension request for extension data associated with at least a first object of the one or more objects.

2. The method of claim 1, further comprising, prior to transmitting the SSM, generating, by the first device, an uncompressed SSM that includes the first data, the second data, and the extension data.

3. The method of claim 2, further comprising determining, by the first device, whether one or more compression criteria are satisfied, wherein the first device transmits the SSM instead of the uncompressed SSM based on identifying that the one or more compression criteria are satisfied.

4. The method of claim 3, wherein the one or more compression criteria are based on one or more of a channel busy rate (CBR) determined by the first device or a number of objects detected by the first device and indicated by the uncompressed SSM.

5. The method of claim 3, wherein the uncompressed SSM has a first data size, and wherein the SSM has a second data size that is less than the first data size.

6. The method of claim 1, further comprising, based on receiving the extension request, determining, by the first device, whether one or more extension response criteria for transmission of an extension response are satisfied.

7. The method of claim 6, further comprising transmitting the extension response indicating the extension data based on determining that the one or more extension response criteria are satisfied.

8. The method of claim 6, further comprising declining to transmit the extension response indicating the extension data based on determining that the one or more extension response criteria are not satisfied.

9. The method of claim 6, wherein determining whether the one or more extension response criteria are satisfied is based on a priority element indicated by the extension request.

10. The method of claim 6, wherein determining whether the one or more extension response criteria are satisfied is based on a number of extension requests received by the first device and indicating the first object.

11. The method of claim 6, wherein determining whether the one or more extension response criteria are satisfied is based on one or more of a channel busy rate (CBR) determined by the first device or a number of objects detected by the first device.

12. The method of claim 1, further comprising:
selecting, by the first device, a transmission mode for an extension response indicating the extension data; and
transmitting, by the first device, the extension response based on the transmission mode.

13. The method of claim 12, wherein the transmission mode corresponds to a unicast transmission mode.

14. The method of claim 12, wherein the transmission mode corresponds to broadcast or groupcast transmission mode, and wherein the first device transmits the extension response to the second device and to one or more other devices.

15. The method of claim 14, further comprising receiving one or more other extension requests from the one or more other devices, wherein the first device selects the broadcast or groupcast transmission mode based on a number of extension requests indicating the first object.

16. The method of claim 14, wherein the first device selects the broadcast or groupcast transmission mode based on determining that that the second device and the one or more other devices are within a particular range of one another.

17. The method of claim 14, wherein the first device transmits the SSM using a first modulation and coding scheme (MCS) and based on a unicast transmission mode, and further comprising selecting a second MCS for transmission of the extension response based on the broadcast or groupcast transmission mode.

18. The method of claim 17, wherein the first MCS is associated with a first spectrum efficiency metric, and wherein the second MCS is associated with a second spectrum efficiency metric that is greater than the first spectrum efficiency metric.

19. The method of claim 17, wherein the SSM is transmitted using a first number of resources, and wherein the extension response is transmitted using a second number of resources that is less than the first number of resources.

20. An apparatus comprising:
a transmitter configured to transmit, from a first device, a sensor sharing message (SSM) associated with a vehicle communication network, wherein the SSM includes first data associated with the first device and further includes second data indicating one or more objects detected by the first device; and
a receiver configured to receive, in response to transmitting the SSM, an extension request from a second device for extension data associated with at least a first object of the one or more objects.

21. The apparatus of claim 20, wherein the first device corresponds to an on-board unit (OBU) of a vehicle, a roadside unit (RSU), or another device that communicates using the vehicle communication network.

22. The apparatus of claim 20, wherein the second device corresponds to an on-board unit (OBU) of a vehicle, a roadside unit (RSU), or another device that communicates using the vehicle communication network.

23. The apparatus of claim 21, wherein the first object corresponds to a vehicle, a vulnerable road user (VRU), or an obstacle.

24. A method of wireless communication, comprising:
receiving, from a first device and by a second device, a sensor sharing message (SSM) associated with a vehicle communication network, wherein the SSM includes first data associated with the first device and further includes second data indicating one or more objects detected by the first device; and
in response to receiving the SSM, transmitting, to the first device by the second device, an extension request for extension data associated with at least a first object of the one or more objects.

25. The method of claim 24, further comprising receiving, from the first device based on the extension request, an extension response indicating the extension data.

26. The method of claim 24, wherein the second device transmits the extension request to the first device based on determining that the extension data is to be used in connection with one or more of a maneuver of the second device or trajectory planning of the second device.

27. The method of claim 24, wherein the second device transmits the extension request to at least one other device.

28. The method of claim 24, wherein the extension request includes a priority element indicating a priority associated with the extension request.

29. An apparatus comprising:
a receiver configured to receive, from a first device and by a second device, a sensor sharing message (SSM) associated with a vehicle communication network, wherein the SSM includes first data associated with the first device and further includes second data indicating one or more objects detected by the first device; and
a transmitter configured to transmit, from the second device to the first device in response to receiving the SSM, an extension request for extension data associated with at least a first object of the one or more objects.

30. The apparatus of claim 29, wherein the first object corresponds to a vehicle, a vulnerable road user (VRU), or an obstacle, wherein the first device corresponds to an on-board unit (OBU) of a vehicle, a roadside unit (RSU), or another device that communicates using the vehicle communication network, and wherein the second device corresponds to an OBU of a vehicle, an RSU, or another device that communicates using the vehicle communication network.
